(19) United States
(12) Patent Application Publication
(10) Pub. No.: US 2006/0039311 A1
(43) Pub. Date: Feb. 23, 2006

(54) Wireless network system and electronic device

(75) Inventor: Seok-woo Yong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/206,079

(22) Filed: Aug. 18, 2005

(30) Foreign Application Priority Data
Aug. 19, 2004 (KR) 10-2004-65563

(51) Int. Cl. H04J 3/08

(52) U.S. Cl. 370/315

(57) ABSTRACT

An electronic device including a wireless LAN module performing predetermined initialization when a predetermined setting time is passed after a channel link is disconnected, and a controller initializing the wireless LAN module when the wireless LAN module does not receive a predetermined response from an external electronic device within a predetermined standby time shorter than the setting time, after transmitting data to the external electronic device. The wireless network system and an electronic device can avoid signal interference and promptly resume data communication even when a channel link is disconnected due to the signal interference.

### CROSS-REFERENCE TO RELATED APPLICATIONS

This application claims priority from Korean Patent Application No. 2004-65563, filed on Aug. 19, 2004 in the Korean Intellectual Property Office, the disclosure of which is incorporated herein by reference.

### BACKGROUND OF THE INVENTION

1. Field of the Invention

The present invention relates to a wireless network system and an electronic device, and more particularly, to a wireless network system and an electronic device, in which initialization is performed regardless of wireless local area network (LAN) modes when a channel link is disconnected, thereby promptly resuming data communication.

2. Description of the Related Art

An operation of a wireless LAN is divided into four states, such as a turn-on mode, a turn-off mode, an association mode, and a connection mode, which are stored as status data.

The wireless LAN is turned on by a user from the turn-off mode, and performs a predetermined initialization operation. At this time, an optimum channel is sought for securing stable communication with other nodes. When the channel seeking is completed, the wireless LAN starts the data communication with other devices through the optimum channel, thereby entering into the connection mode.

As international standards for wireless LAN, an Institute of Electrical and Electronics Engineers (IEEE) 802.11 standard defines specifications of a media access control (MAC) layer and a physical layer. The IEEE 802.11 standard is divided in detail into 802.11, 802.11a, 802.11b and 802.11g, which are different in a frequency band, transmission speed, modulation method, etc.

In the case of a wireless network system employing an IEEE 802.11b/g wireless LAN, the data communication between the nodes are achieved by several channels having a uniform band at 2.4 GHz. Meanwhile, there is an electronic device that radiates a strong electromagnetic wave regardless of the data communication. This electromagnetic wave has an effect on the data communication of a certain band.

FIG. 1A illustrates a spectrum of electromagnetic waves generated while a microwave oven is operating, and FIG. 1B illustrates a band of a 802.11b/g wireless LAN.

The frequency band including a peak value in the spectrum of FIG. 1A belongs to a portion of the second channel band of FIG. 1B. Therefore, when data communication is performed using this channel band, communication error occurs, so that a channel link is likely to be disconnected.

When the channel link is disconnected, the wireless LAN keeps the association mode trying data communication, occupying a prior channel for about 10 seconds. After a lapse of about 10 seconds, the wireless LAN itself initializes the operation, thereby seeking a good status channel and resuming the data communication.

In the case where real time communication is important, 10 seconds taken to keep the association mode of the wireless LAN is a relatively very long time. For example, if a moving picture is transmitted by real-time data communication and displayed on a television, a user would feel that the time taken to keep the association mode is too long. Besides, the time for keeping the association mode of the wireless LAN is invariably settled by a manufacturer, so that it is impossible to adjust the association mode keeping time suitably for the real-time data communication.

Thus, in the conventional wireless network system using the wireless LAN, there is a problem in that it is impossible to promptly resume the data communication when the channel link is disconnected.

### SUMMARY OF THE INVENTION

Accordingly, it is an aspect of the present invention to provide a wireless network system and an electronic device, which can avoid signal interference and promptly resume data communication even when a channel link is disconnected due to signal interference.

The foregoing and/or other aspects of the present invention are also achieved by providing an electronic device comprising a wireless LAN module performing predetermined initialization when a predetermined setting time is passed after a channel link is disconnected, the electronic device further comprising a controller initializing the wireless LAN module when the wireless LAN module does not receive a predetermined response from an external electronic device within a predetermined standby time shorter than the setting time, after transmitting data to the external electronic device.

According to an aspect of the present invention, the electronic device performs data communication with the external electronic device on the basis of a 802.11 standard and has an ad-hoc network environment.

The foregoing and/or other aspects of the present invention are also achieved by providing a wireless network system comprising a display and an electronic device, the electronic device comprising a wireless LAN module; and a controller initializing the wireless LAN module when the wireless LAN module does not receive a predetermined response from an external electronic device within a predetermined standby time after transmitting an audio/video signal to the external electronic device through the wireless LAN module.

According to an aspect of the present invention, the wireless LAN module performs predetermined initialization when predetermined setting time is passed after a channel link is disconnected, and the standby time is shorter than the setting time.

### BRIEF DESCRIPTION OF THE DRAWINGS

The above and/or other aspects of the present invention will become apparent and more readily appreciated from the following description of exemplary embodiments, taken in conjunction with the accompany drawings of which:

FIG. 1A illustrates a spectrum of electromagnetic waves generated while a microwave oven is operating;

FIG. 1B illustrates a band of a 802.11b/g wireless LAN;

FIG. 2 is a block diagram of an electronic device being linked in a wireless network system according to an exemplary embodiment of the present invention;

FIG. 3 is a flowchart of a data communication method based on a handshake according to an exemplary embodiment of the present invention; and

FIG. 4 illustrates channel links in a frequency spectrum.

### DETAILED DESCRIPTION OF THE EXEMPLARY EMBODIMENTS

Reference will now be made in detail to exemplary embodiments of the present invention, examples of which are illustrated in the accompanying drawings, wherein like reference numerals refer to like elements throughout. The exemplary embodiments are described below in order to explain the present invention by referring to the figures.

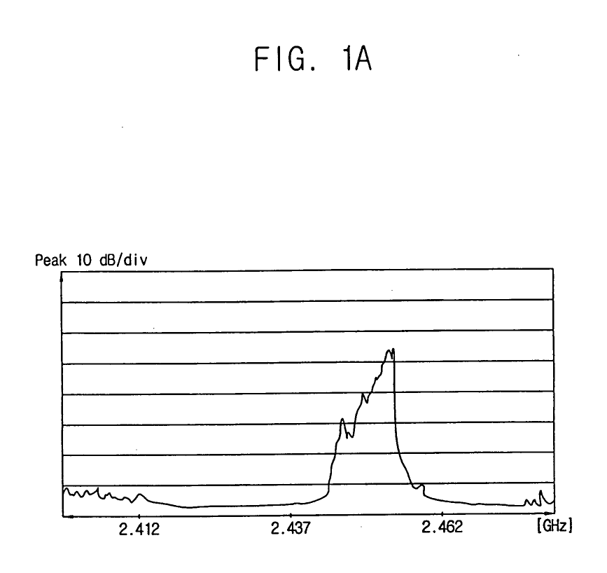

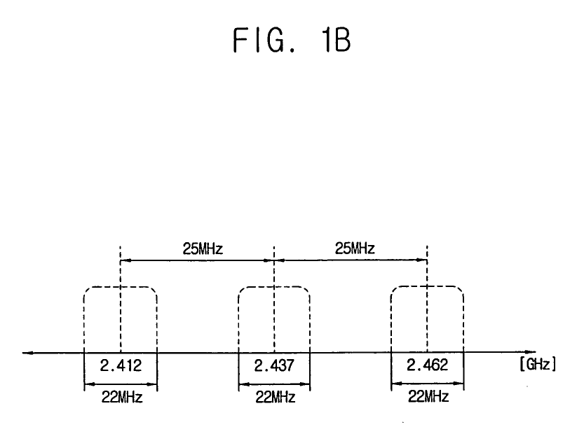

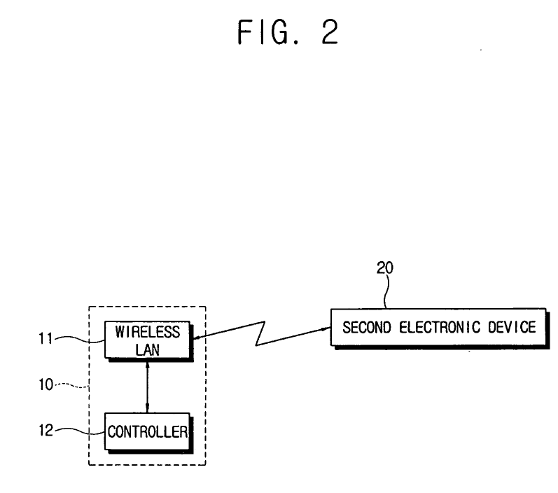

FIG. 1A illustrates a spectrum of electromagnetic waves generated while a microwave oven is operating, and FIG. 1B illustrates a band of a 802.11b/g wireless LAN. FIG. 2 is a block diagram of an electronic device being linked in a wireless network system according to an exemplary embodiment of the present invention.

As shown in FIG. 2, a wireless network system according to an exemplary embodiment of the present invention comprises a first electronic device 10 and a second electronic device 20, which are linked to each other. Each of the first and second electronic devices 10 and 20 is provided with a wireless LAN module 11.

The first and second electronic devices 20 can be selected as a mobile node or a stationary node in an ad-hoc network environment. For example, the first and second electronic devices 10 and 20 include various electronic devices such as a mobile phone, a portable computer, an access point, a television, a camcorder, a camera, a washing machine, a refrigerator, etc.

The first electronic device 10 further comprises a controller 12 in addition to the wireless LAN module 11.

The controller 12 applies a signal process to data transmitted to and received from the wireless LAN module 11. Here, the controller 12 comprises a sub-controller for controlling data communication; an encoder and a decoder for the signal process; a memory for storing the data; etc.

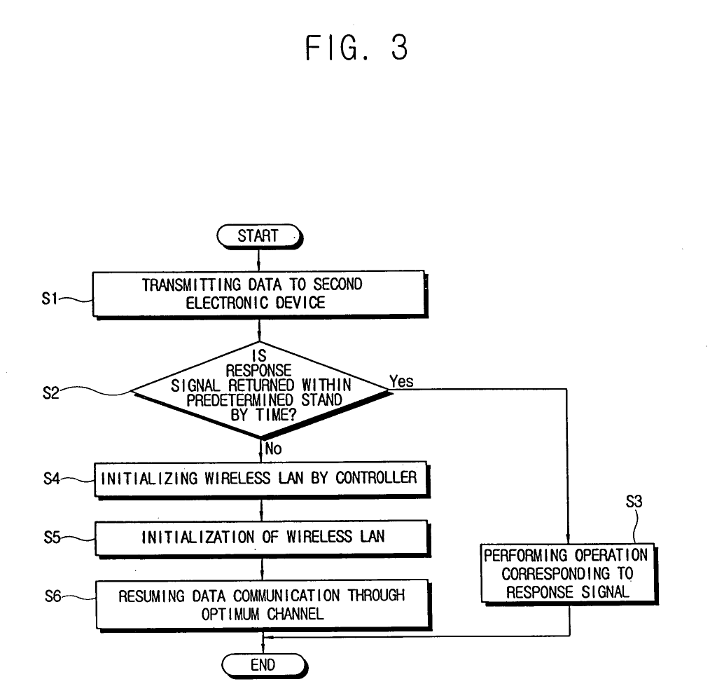

FIG. 3 is a flowchart of a data communication method based on a handshake according to an exemplary embodiment of the present invention.

Hereinbelow, operations of the electronic devices of FIG. 2 will be described with reference to FIG. 3.

First, at operation S1, the controller 12 transmits the data to the second electronic device 20 through the wireless LAN module 11. At operation S2, the controller 12 determines whether the second electronic device 20 returns a response signal to the data within a predetermined standby time from the beginning of data transmission. Here, the second electronic device 20 can include a display, and the data can include an audio/video signal.

When the response signal is returned from the second electronic device 20, at operation S3, the controller 12 performs an operation corresponding to the response signal.

For example, in the case where the controller 12 receives an acknowledgement signal from the second electronic device 20, the controller 12 transmits the next data packet. In the case where the controller 12 receives a request signal for the prior data packet, the controller 12 transmits the corresponding data packet.

On the other hand, in the case where the controller 12 does not receives any response signal within the standby time, at operation S4, the controller 12 determines that the channel link is disconnected, and initializes the wireless LAN module 11. Here, the channel link of the wireless LAN 11 in a predetermined channel band may be disconnected by interference due to the electromagnetic wave radiated from electronic appliances such as a microwave oven (refer to FIGS. 1A and 1B).

Thus, at operation S5, the wireless LAN module 11 performs the initialization even while the association mode is kept, thereby seeking the optimum channel for the data communication.

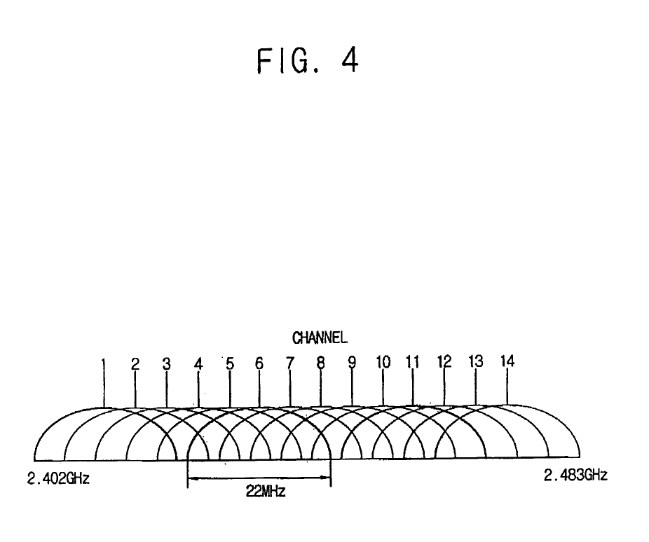

As shown in FIG. 4, when the sixth channel link is disconnected, the wireless LAN module 11 performs the initialization to check the link state of the other channels, and sets the optimum channel.

When the initialization is completed, at operation S6, the controller 12 is connected to the second electronic device 20 through the optimum channel and resumes the data communication.

Here, the standby time during which the controller 12 waits to receive the acknowledge signal from the second electronic device 20 is shorter than the channel occupying time of the association mode set in the wireless LAN module 11. Because it is possible that the channel link is recovered and the stable data communication is performed through the prior channel, the standby time is preferably shorter than the channel occupying time but is long to somewhat keep the association mode of the wireless LAN module 11.

As described above, the present invention provides a wireless network system and an electronic device, which can avoid signal interference and promptly resume data communication even when a channel link is disconnected due to signal interference.

Although exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. An electronic device comprising:
a wireless local area network (LAN) module which performs predetermined initialization if a predetermined setting time passes after a channel link is disconnected; and
a controller which initializes the wireless LAN module if the wireless LAN module does not receive a predetermined response from an external electronic device within a predetermined standby time which is shorter than the predetermined setting time, after transmitting data to the external electronic device.

2. The electronic device according to claim 1, wherein data communication is performed with the external electronic device on the basis of an IEEE 802.11 standard in an ad-hoc network environment.

3. A wireless network system comprising a display and an electronic device, wherein the electronic device comprises:
a wireless local area network (LAN) module; and
a controller which initializes the wireless LAN module if the wireless LAN module does not receive a predetermined response from an external electronic device within a predetermined standby time after transmitting an audio/video signal to the external electronic device through the wireless LAN module.

4. The wireless network system according to claim 3, wherein the wireless LAN module performs a predetermined initialization if a predetermined setting time passes after a channel link is disconnected, and the predetermined standby time is shorter than the predetermined setting time.

5. A method of controlling an electronic device comprising a wireless local area network (LAN) module, the method comprising:
transmitting data to an external electronic device through the wireless LAN module;
determining whether a predetermined response is received from the external electronic device within a predetermined standby time shorter than a predetermined setting time; and
initializing the wireless LAN module if the wireless LAN module does not receive the predetermined response from the external electronic device within the predetermined standby time.

6. The method according to claim 5, further comprising:
performing an operation corresponding to the predetermined response if the wireless LAN module receives the predetermined response from the external electronic device.

7. The method according to claim 5, wherein data communication is performed with the external electronic device on the basis of an IEEE 802.11 standard in an ad-hoc network environment.

8. The method according to claim 5, wherein the wireless LAN module performs a predetermined initialization if the predetermined setting time passes after a channel link is disconnected.
